(19) United States
(12) Patent Application Publication
(10) Pub. No.: US 2003/0122937 A1
(43) Pub. Date: Jul. 3, 2003

(54) Method for processing digital CFA images, particularly for motion and still imaging

(76) Inventors: Mirko Guarnera, Gela (Caltanissetta) (IT); Massimo Mancuso, Monza (Milano) (IT); Jonathan Hurwitz, Edinburgh (GB); Stewart Smith, Edinburgh (GB); Keith Findlater, Edinburgh (GB)

Correspondence Address: Bryan A. Santarelli/KDJ, Graybeal Jackson Haley LLP, 155-108th Avenue NE, Suite 350, Bellevue, WA, 98004, US

(21) Appl. No.: 10/290,046

(22) Filed: Nov. 6, 2002

(30) Foreign Application Priority Data
Nov. 6, 2001 (EP) 01830685.2

(51) Int. Cl. H04N 5/225; H04N 5/228; H04N 3/14

(52) U.S. Cl. 348/220.1; 348/280; 348/222.1

(57) ABSTRACT

A method of processing digital images in devices for acquiring both individual images and image sequences, comprising the step of acquiring images in color filter array (CFA) format and the step of reducing the resolution of the images acquired. In order to reduce computing time and energy consumption, the resolution-reduction step processes the images directly in CFA format.

### PRIORITY CLAIM

This application claims priority from European patent application No. 01830685.2, filed Nov. 6, 2001; and is herein incorporated by reference.

### TECHNICAL FIELD OF THE INVENTION

The present invention relates to the acquisition and processing of images in digital format and, in particular, relates to a method of processing digital Color Filter Array (CFA) images, which is usable advantageously in devices such as, for example, digital cameras intended for acquiring both individual images for photographic applications and moving images for video applications.

### BACKGROUND OF THE INVENTION

Digital still cameras, or DSCs, are currently among the most common devices used for acquiring digital images. The ever-increasing resolution of the sensors on the market and the availability of low-consumption digital-signal processors (DSPs) have led to the development of digital cameras which can achieve quality and resolution very similar to those offered by conventional cameras.

As well as being able to capture individual images (“still imaging”), the most recent digital cameras can also acquire video sequences (“motion imaging”).

In order to produce a video sequence, it is necessary to acquire a large number of images taken at very short intervals (for example 15 images per second). The processed and compressed images are then encoded into the most common digital video formats (for example, MPEG-4).

In devices that can acquire both individual images and video sequences, there are two conflicting requirements. For photographic applications, that is to say for still imaging, high resolution and quality and a large processing capacity are required, even at the expense of acquisition speed and memory occupation. In contrast, for video applications, a fast acquisition speed and optimisation of memory resources are required, at the expense of resolution and quality.

The same remarks are applicable to future multimedia communication terminals such as, for example, third-generation mobile telephones or PDA palmtop computers (portable digital assistants); these should be able to acquire both individual images and video sequences.

A digital image is constituted by a matrix of elements or pixels; each pixel corresponds to a basic fragment of the image and is represented by one or more digital values, each associated with a different optical component.

With reference to FIG. 1, a digital camera 1 for photographic and video applications includes an acquisition block 2 comprising a lens and diaphragm 3 and a sensor 4 onto which the lens focuses an image representative of a real scene.

Irrespective of whether the sensor 4 is of the CCD (Charge Coupled Device) or CMOS type, it is an integrated circuit comprising a matrix of photosensitive cells each of which generates a voltage proportional to the exposure to which it is subjected.

The voltage generated by each photosensitive cell is translated into a digital value by an A/D converter 5. This value may be represented by 8, 10 or 12 bits, according to the dynamics of the camera.

In a typical sensor, a single photosensitive cell is associated with each pixel. The sensor is covered by an optical filter constituted by a matrix of filter elements each of which is associated with a photosensitive cell. Each filter element transmits to the photosensitive cell associated therewith the luminous radiation corresponding to the wavelength solely of red light, solely of green light, or solely of blue light (absorbing a minimal portion thereof), so that only one component, that is, the red component, the green component, or the blue component, is detected for each pixel.

The type of filter used varies according to the manufacturer; the most commonly used is known as a Bayer filter. In this filter, the arrangement of the filter elements, which is known as the Bayer pattern, is determined by the basic matrix BM shown in FIG. 2.

With a filter of this type, the green component (G) is detected by half of the pixels of the sensor, with a chessboard-like arrangement; the other two components are detected by the remaining pixels that are arranged in alternating rows.

The image output by the analog/digital converter 5 is an incomplete digital image because it comprises a single component (R, G or B) per pixel. The format of this image is conventionally referred to as a Colour Filter Array (CFA).

This image is sent to the input of a pre-processing unit PrePro 6; this unit is active prior to and during the entire acquisition stage, interacts with the acquisition block 2, and estimates, from the incomplete CFA image, various parameters which are useful for performing automatic control functions, that is: auto-focus, auto-exposure, correction of sensor defects, and white balancing functions.

The incomplete CFA digital image is then sent to a unit 7, known as the Image Generation Pipeline (IGP) which is composed of several blocks. Starting with the CFA image, a block 8, known as ColorInterp, generates, by means of an interpolation process, a complete RGB digital image in which a set of three components corresponding to the three R, G and B components is associated with each pixel. This conversion may be considered as a transition from a representation of the image in a single plane (Bayer) to a representation in three planes (R, G, B).

This image is then processed by the ImgProc block 9 which is provided for improving quality. Several functions are performed in this block 9. They are exposure correction, filtering of the noise introduced by the sensor 4, application of special effects, and other functions, the number and type of which vary from one manufacturer to another.

The complete and improved RGB image is passed to the block 10, which is known as the scaling block. This block 10 reduces the resolution of the image, if required. An application which requires the maximum available resolution, equal to that of the sensor (for example, a high-resolution photograph), does not require any reduction in resolution. If, however, the resolution is to be halved, for example, for a film, the scaling block 10 eliminates three quarters of the pixels.

After scaling, the RGB image is converted, by the block 11, into the corresponding YCbCr image in which each pixel is represented by a luminance component Y and by two chrominance components Cb and Cr. This is the last step performed in the IGP 7.

The next block is a compression/encoding block 12. Generally, the block 12 uses JPEG for individual images and MPEG-4 for video sequences.

The resolution necessary for video applications is lower than that required for photographic applications but, according to the prior art, the sensor and the IGP 7 nevertheless work at maximum resolution, even for acquiring video sequences.

This leads to wasted computation, which translates into an enormous consumption of processing resources and unnecessary occupation of memory.

### SUMMARY OF INVENTION

A method according to an embodiment of the invention prevents or limits the problems of the prior art. This method provides for the resolution of the images to be reduced directly in CFA format.

### BRIEF DESCRIPTION OF DRAWINGS

The invention will be understood further from the following detailed description of two embodiments of this method, given with reference to the appended drawings, in which:

FIG. 1 is a block diagram of a digital camera according to the prior art,

FIG. 2 shows the elementary matrix of a conventional Bayer sensor filter,

FIG. 3 is a block diagram of a first digital camera that uses the method according to an embodiment of the invention,

FIG. 3a shows a possible implementation of a method according to an embodiment of the invention, and

FIG. 4 is a block diagram of a second digital camera that uses the method according to an embodiment of the invention.

### DETAILED DESCRIPTION OF THE DRAWINGS

The following discussion is presented to enable a person skilled in the art to make and use the invention. The general principles described herein may be applied to embodiments and applications other than those detailed below without departing from the spirit and scope of the present invention. The present invention is not intended to be limited to the embodiments shown, but is to be accorded the widest scope consistent with the principles and features disclosed or suggested herein.

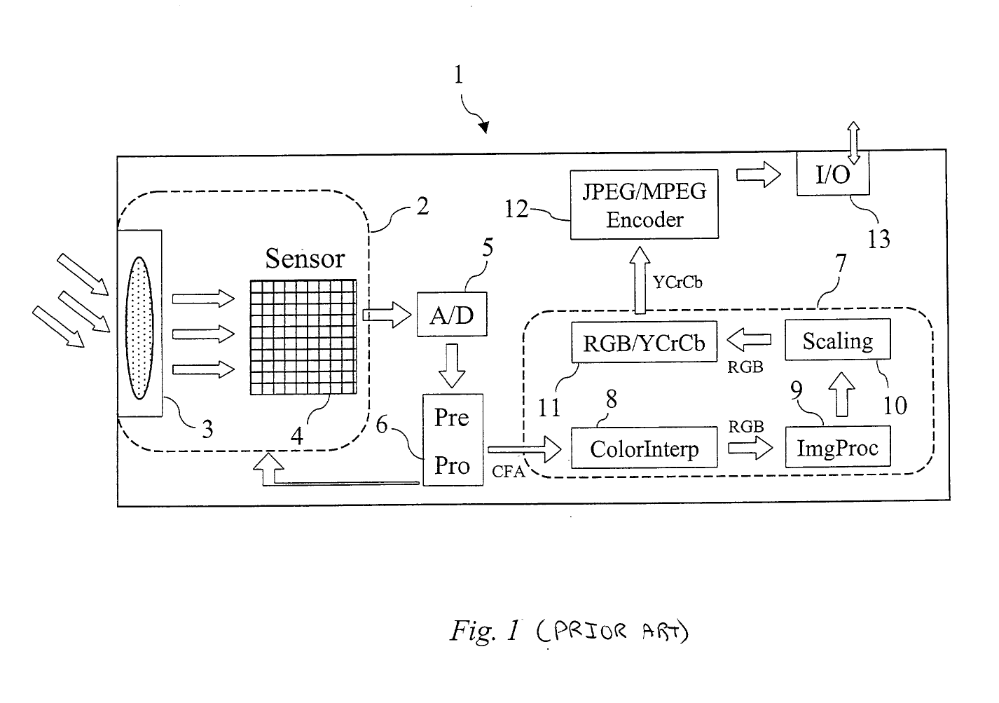

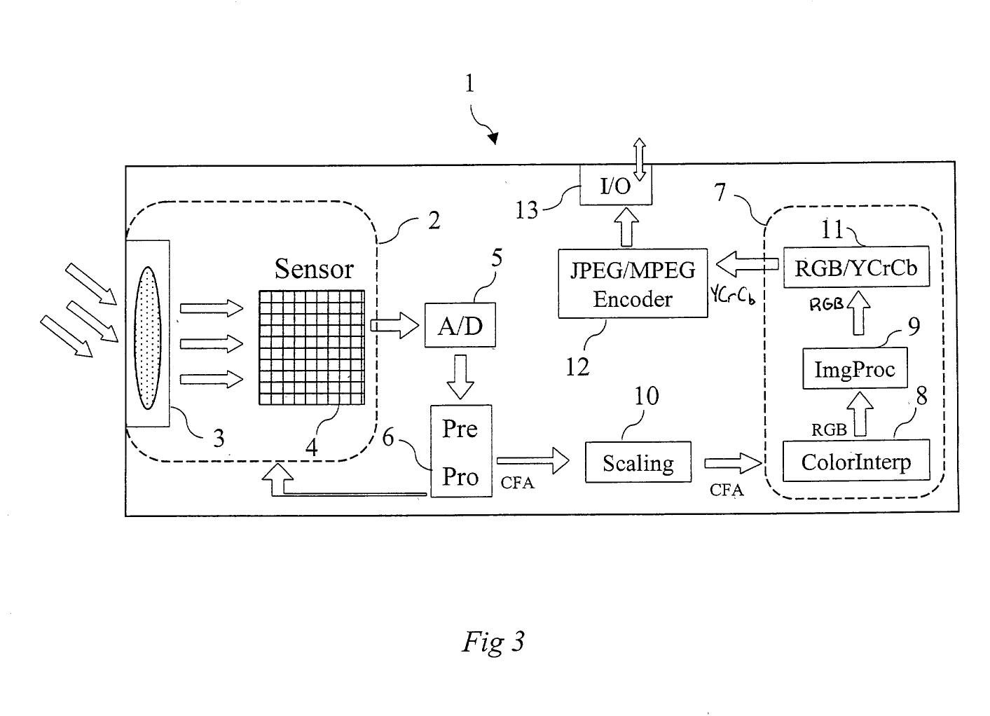

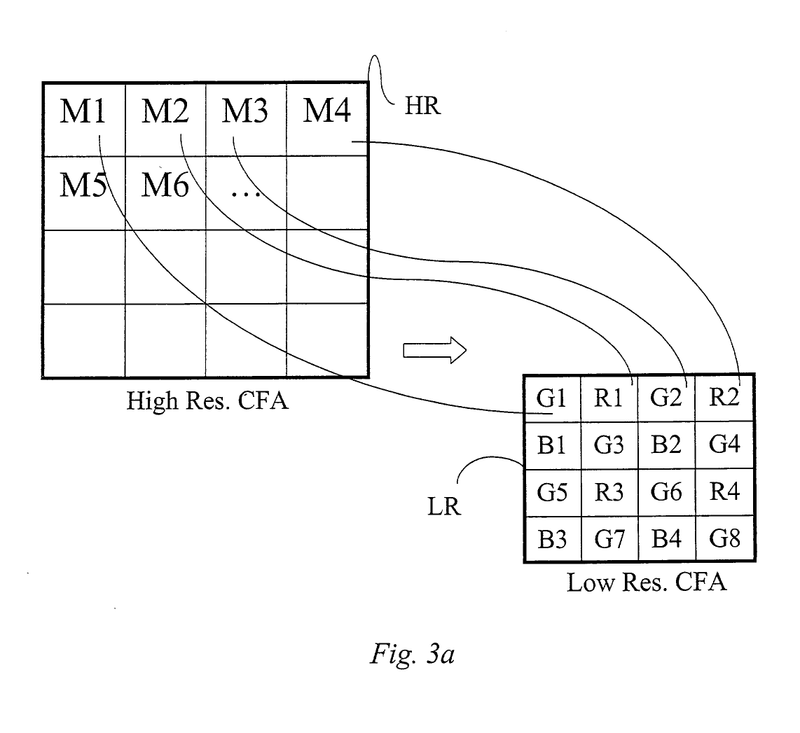

As can be seen in FIG. 3, in which blocks that are identical or equivalent to those of FIG. 1 are indicated by the same reference numerals or symbols, the digital camera 1 uses a method according to an embodiment of the invention. The scaling algorithm 10, which is provided for reducing resolution, acts directly on the incomplete CFA image, prior to the interpolation process which reconstructs the three R, G, B planes. Moreover, as can be noted in FIG. 3, the scaling algorithm 10 provides scaled CFA images.

The scaling algorithm 10 performs two operations. First, the image is processed by an anti-aliasing digital low-pass filter and is sub-sampled in the spatial domain. The sub-sampling produces an image which is scaled by a predetermined factor in each dimension.

For example, M×N scaling reduces one dimension by a factor M and the other by a factor N. The sub-sampling process consists in breaking the image down into adjacent and non-overlapping blocks of pixels with dimensions of M×N, and, in replacing each block with a single pixel the intensity of each pixel is obtained, for example, by averaging the intensities of the M×N pixels making up the block. According to conventional scaling techniques, it is also possible that the adjacent blocks are partially overlapped.

According to the prior art, the resolution-reduction algorithms operate on RGB images, that is, on images which are composed of three distinct and complete planes. Each component is processed separately since these algorithms are applied separately to the three monochromatic images corresponding to the three RG and B planes.

In an embodiment of the present invention, however, the resolution-reduction algorithm operates on an incomplete CFA image in which the pixels of the R G B planes form part of a single plane and are interlaced in accordance with the Bayer-pattern matrix.

In practice, a scaling algorithm which works directly on CFA images can be implemented by adapting known scaling algorithms in a manner such that they operate directly on the Bayer pattern and can act selectively on the pixels associated with different colors.

An example of a scaling method according to an embodiment of the present invention will be given with reference to FIG. 3a. A starting high resolution CFA digital image HR is first subdivided into blocks M1, M2, M3, . . . , MN of pixels.

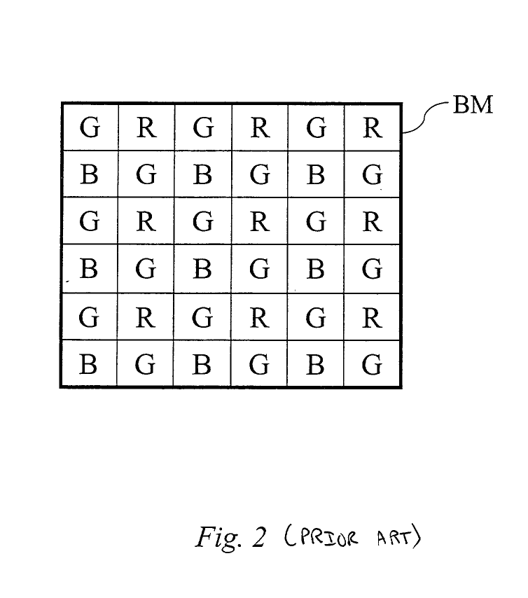

Each block M1, M2, M3, . . . , MN then is processed to produce a single colored pixel of a low-resolution image LR. For example, the block M1, which contains blue, red, and green pixels according to the arrangement of the Bayer-pattern (see matrix BM in FIG. 2) where, for example, M=N≧2, is processed to produce a green pixel G1 in the low-resolution image LR. Then, the block M2 is processed to produce a red pixel R1 and so forth. Hence, the output pixel is associated with a color that is set in such a way that the low-resolution image LR is still a Bayer CFA image.

According to one embodiment, to obtain a “low-resolution pixel” (for example, G1) associated with a pre-established color (for example, green), a high-resolution block (in the example M1) is processed by calculating the low resolution pixel (i.e. G1) as an average (for example, weighted) of all the pixels having the pre-established color and belonging to the high-resolution block. However, other similar choices are possible.

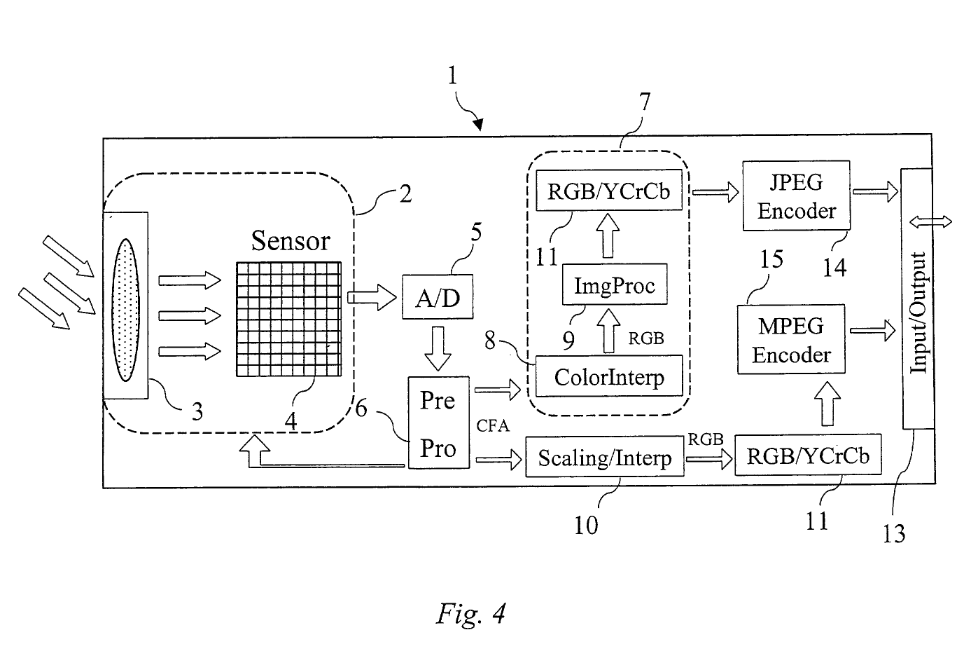

With reference to FIG. 4, in which blocks that are identical or equivalent to those of FIG. 1 are indicated by the same reference numerals or symbols, another digital camera 1, which uses the method according to an embodiment of the invention, enables images for photographic applications to be processed in a different manner from video-sequence photograms.

The maximum-resolution photographic images output by the PrePro block 6 are subjected to processing by the known technique and are sent to a JPEG encoder 14.

The images making up video sequences are processed by the block 10 which combines both scaling and color interpolation. It is, in fact, possible to form a block which performs anti-aliasing filtering, under-sampling, and interpolation, simultaneously. It is, in fact, known that the two operations (scaling and interpolation) are both determined by a convolution matrix. A single convolution matrix can be associated with the two blocks in series; the entire process is, thus, performed in a single operation.

The RGB signal output by the block 10 is converted directly into an YCrCb signal by the block 11 and is then sent to the MPEG encoding block 15.

After interpolation, the video-sequence images thus undergo no further preparation or processing; in contrast with what happens with photographic images, any improvements introduced at this point would represent an unnecessary waste of computation since they would be almost completely cancelled out by the losses in quality introduced by the MPEG encoding.

The above-described embodiments of the above-described invention reduce computing cost, energy consumption, and memory occupation during the acquisition of video sequences with devices which can also acquire high-resolution individual photographs.

In particular, the embodiment (represented in FIGS. 3 and 3a) in which the scaling is kept as an elaboration distinct from the color interpolation is particularly advantageous.

In this case, in fact, after the scaling, the CFA images with reduced resolution can be processed by a conventional standard Image Generation Pipeline 7, which therefore, do not need to be re-designed or modified. Moreover, as the processing routines for the improvement of the image quality (which are traditionally implemented in the IGP 7) can still be used, high quality interpolated images with reduced resolution can be provided at the output of the IGP 7.

In addition, as in this case, the only operations required to the scaling method are the anti-aliasing filtering and the color-selective sub-sampling (CFA scaling), it is possibly to simply design a cost-effective sensor which is able to perform in hardware both these operations.

For these reasons, the above referred embodiment allows reaching the best trade-off among: image-quality, reduced processing complexity, saving of memory resources, and cost-effective implementation.

With reference to a digital camera according to the prior art as shown in FIG. 1, having a VGA sensor 4 (640×480), to obtain a video sequence encoded in accordance with the MPEG-4 standard, the scaling algorithm implemented by the block 10 would have to reduce VGA images to a QCIF format (176×144).

Upon the assumption that an 8-bit A/D converter 5 is used, the VGA Bayer image would have a size of 330 kbytes. Since an MPEG-4 sequence requires 15 images per second, the input of the ColorInterp block 8 would receive a 4.5 Mbyte/s data stream in order to generate an output stream of 13.5 Mbyte/s. This enormous quantity of data would be processed by the ImgProc block 9 and would be reduced, after scaling, to a stream of 1.14 Mbyte/s.

According to an embodiment of the present invention, in a digital camera such as that shown in FIG. 3, the original 330 kbyte image acquired by the same VGA sensor 4 in CFA format is immediately reduced to a 25 kbyte CFA image in QCIF format by the scaling block 10.

A 380 kbyte stream produced by 15 images per second in this format is present at the input of the interpolation block 8. The interpolation triples the size of the data; the ImgProc block 9 operates on a stream of only 1.14 Mbyte/s.

According to an embodiment of the present invention, in this example, the interpolation block 8 and the ImgProc block 9 process a quantity of data the size of which is one order of magnitude less than that processed according to the prior art.

The example calculation given assumed the use of a VGA sensor (307,200 pixels). Thus, the advantages of the above-described embodiments of the invention, in terms of computational saving, are even clearer when one considers that sensors can currently achieve a resolution of 6-7 million pixels.

We claim

1. A system for processing digital images, the system comprising:
an image-acquisition device operable to acquire an image in a Color Filter Array (CFA) format and having a plurality of pixels; and
a processor operable to reduce the resolution the CFA image by applying a resolution-reducing algorithm to the CFA image.

2. The system of claim 1 wherein the processor is further operable to perform anti-alias filtering of the CFA image.

3. The system of claim 1 wherein the image acquisition device comprises an optical sensor having photosensitive elements associated with filter elements arranged in a Bayer pattern.

4. The system of claim 3 wherein the optical sensor comprises a charge-coupled device sensor.

5. The system of claim 3 wherein the optical sensor comprises a CMOS-type sensor.

6. The system of claim 1, further comprising an interpolator operable to interpolate the resolution-reduced CFA image into a color image.

7. The system of claim 1, further comprising an interpolator operable to interpolate the resolution-reduced CFA image into an R,G,B image.

8. The system of claim 1, further comprising an interpolator operable to interpolate the resolution-reduced CFA image into a Y, Cr, Cb image.

9. The system of claim 1, further comprising an encoder operable to encode the resolution-reduced image into a JPEG format.

10. The system of claim 1, further comprising an encoder operable to encode the resolution-reduced image into an MPEG format.

11. A method for processing digital images in CFA format, each represented by a respective matrix of pixels, said method comprising reducing the resolution of the images by means of a sub-sampling of the pixels, wherein the resolution reduction step is performed directly on the digital CFA images and provides digital CFA images with reduced resolution.

12. A method according to claim 11, in which the digital images in CFA format are acquired by means of an optical sensor having photosensitive elements associated with filter elements arranged in accordance with the Bayer pattern.

13. A method according to claim 11 in which the resolution-reduction step includes a step for anti-aliasing digital filtering of the CFA images.

14. A method according to claim 11 in which, after the resolution-reduction step, the CFA images are subjected to an interpolation step.

15. A method according to claim 14, in which the interpolation step produces complete images in R,G,B, format.

16. A method according to claim 14 in which the interpolation step produces complete images in Y,Cr,Cb format.

17. A method according to claim 14, in which the step of reducing the resolution of the CFA image and the interpolation step are performed by a single algorithm based on the product of convolution of the CFA image with convolution matrices which simultaneously perform both of the above-mentioned functions.

18. A method of operation of a device for acquiring photographic images and video-sequence images by means of a same sensor, in which the video-sequence images are processed by a method according to claim 11, and further comprising:
acquiring images in CFA format during a pre-processing step; and
processing and interpolating the CFA images immediately after the pre-processing step in order to perform all of any subsequent processing operations on interpolated images.

19. A method for processing digital images comprising:
acquiring a first image having a plurality of pixels in a CFA format;
reducing the resolution of the first image;
interpolating the first resolution-reduced image; and
encoding the first interpolated resolution-reduced image into an MPEG format.

20. The method of claim 19, further comprising:
acquiring a second image having a plurality of pixels in a CFA format;
interpolating the second image; and
encoding the second interpolated resolution-reduced image into an JPEG format.

21. A system for processing digital images, the system comprising:
an image-acquisition device operable to acquire a video image having a plurality of pixels in a CFA format; and
a first pre-processing block operable to reduce the resolution of the video image by applying a resolution-reducing algorithm directly to the video image and operable to interpolate the video image into a color image.

22. The system of claim 21, further comprising:
a second pre-processing block operable to interpolate a still image captured by the image acquisition device into a color still image.

23. The system of claim 20 wherein the image acquisition device comprises an optical sensor having photosensitive elements associated with filter elements arranged in a Bayer pattern.
